(19) United States
(12) Patent Application Publication
(10) Pub. No.: US 2012/0260233 A1
(43) Pub. Date: Oct. 11, 2012

(54) METHOD AND SYSTEM FOR AUTOMATING DEVELOPMENT AND CUSTOMIZATION OF BUSINESS APPLICATIONS

(75) Inventors: Satadal Bandyopadhyay, Calcutta (IN); Chandradeep Bandyopadhyay, Bengaluru (IN); Vikram M. Neginhal, Belgaum (IN)

(73) Assignee: INFOSYS TECHNOLOGIES LIMITED, Bangalore (IN)

(21) Appl. No.: 13/407,985

(22) Filed: Feb. 29, 2012

(30) Foreign Application Priority Data
Apr. 7, 2011 (IN) 1204/CHE/2011

(51) Int. Cl. G06F 9/44

(52) U.S. Cl. 717/107

(57) ABSTRACT

A method and a system have been presented to automate the development and customization of one or more business applications. The system is disclosed in the form of a framework, such as a Rapid Design Toolkit (RDT). Various examples of business applications may include Order Management, Inventory Management, Enterprise Resource Planning (ERP), and Supply Chain Management (SCM). The business applications help in improving operational efficiency and effectiveness of an enterprise. The method described above includes identifying one or more business requirements of a business application by an enterprise. Thereafter, logic is designed using one or more predefined reusable components based on the business requirements. The predefined reusable components are pretested. Thereafter, the designed logic is executed to automatically develop and/or customize the business application. The business application is developed and/or customized visually through configurations.

This application claims the benefit of Indian Patent Application Filing No. 1204/CHE/2011, filed Apr. 7, 2011, which is hereby incorporated by reference in its entirety.

### FIELD OF THE INVENTION

The present invention relates, in general, to the domain of software packages or business applications and, in particular, to a method and a system for automating development and customization of business applications.

### BACKGROUND

In the fast-paced competitive world, businesses are expected to reach global audience. The paradigm shift in the business world over the past years has resulted in a change in business needs and customer demands, thereby forcing enterprises to adapt and evolve faster than ever. As a result, the enterprises have to face challenges of streamlining their business processes and improving operational efficiency. To meet these challenges and to help these businesses sustain, service providers, such as software development companies, play a vital role. The software development companies provide business solutions to the enterprises to respond quickly to the changing business requirements, customer demands, development of new products, and ever-changing market pressures. These business solutions help in controlling a number of business activities, for example, purchasing, inventory management, sales, customer service, accounting, information management, and e-commerce. Therefore, when business solutions/software solutions are applied across various industries/enterprises, they help in meeting the needs of contemporary business requirements. Following are the various examples of such business solutions: Human Resource Management (HRM), Supply Chain Management (SCM), Customer Relationship Management (CRM), Inventory Management, Enterprise Content Management (ECM), Enterprise Resource Planning (ERP), etc. Additionally, these business solutions act as the backbone of e-business.

Traditionally, business applications were developed using a programming approach. Further, business applications were developed in various programming languages according to business requirements and ease of use. Examples of some popular programming languages are C, C# (ASP.Net), C++, Visual Basic (VB), VB.Net, Visual FoxPro, Pearl, Java, and JavaScript. Overall, the processes of developing a business application involves identifying business requirements, designing the business requirements, writing software code, testing the code, implementing the application and maintaining/iterating the application. Once the business application is developed, it is deployed by enterprises at their end to improve the operational efficiency and effectiveness. The business application as developed is often known as core business application package. As described above, this conventional approach of developing the business application involves a lot of effort and time of programmers. Further, the programmers required to be highly skilled and should have in-depth functional knowledge. Moreover, the core business application package, as developed, requires maintenance. The package developed using this conventional approach leads to difficulty in code maintenance since it needs a good amount of documentation and a high amount of expertise.

In general, functionalities provided by the core application package are able to meet majority of the enterprise's solution requirements. However, additional functionalities can be achieved through customizations/extensions when there is a change in business needs and customer demands. The process of modifying the core business application package according to the business requirements is referred to as customization. To match with the modified business requirements, most of the enterprises rely on modifying the existing code in line with the current business requirements. Although the time required for writing the core code has been reduced, a huge amount of time and effort is still spent by the programmers to write custom code every time, even for common business requirements. Thus, similar to the development of business application, customization also focuses on the programming approach, where a huge amount of time is incurred on designing, extension of programs/codes and maintaining the programs in future. Therefore, customization is also a skilled work and requires “core” technology skills with in-depth package and functional knowledge.

To overcome the issues above, a number of methods and products are available in the market. These methods focus on developing or customizing the business application package using the existing Application Program Interfaces (APIs), components, and tools. Accordingly, the effort and time required for writing large codes have been reduced to a certain extent. However, there are a lot of disadvantages associated with the existing methods. One of the disadvantages is that the components and the APIs as provided by these methods are not commonly used across various business application packages. Therefore, an effort for customizing the APIs and components according to the changing business requirements still requires a lot of work, which in turn becomes an effort-intensive task. In other words, these methods fail to provide proper reusable components which can help reduce time and effort considerably. Further, these solutions fail to provide proper abstraction at the component level. Due to the lack of proper abstraction at the component level, the business application package becomes significantly complex, which in-turn makes the maintenance difficult. Moreover, each component and API, once developed or customized, are needed to undergo a thorough testing, thereby, increasing the testing as well as the implementation time. Additionally, the end product becomes solution implementer's responsibility, which includes support, performance ownership, and upgrades.

To overcome the challenges described above, there exists a need of a framework which provides an automated approach for developing and/or customizing business application packages. Such a framework should enable considerable saving on time and effort required by programmers to write software codes. It should also enhance the capability of the programmers/designers to develop and/or customize the business application packages. The framework above should facilitate business components, which can be commonly used across different business application packages, thereby bringing in a level of standardization to development and/or customization process. The business components should be prepared in such a way that the overall time for testing the entire packages after development and/or customization gets reduced. This, in turn, will reduce the implementation time. Moreover, such a framework would enable shifting the focus of control of the final solution from implementers to the designers.

### SUMMARY

The present invention describes a method for automatically customizing one or more business applications. The business applications help an enterprise to streamline their business processes and to improve operational efficiency. The method includes identifying one or more extensible business requirements of a business application. The extensible business requirements are identified by the enterprise when there is a change in business demands. After identifying the extensible requirements, logic is designed using one or more pre-defined reusable components, based on the extensible business requirements. The pre-defined reusable components are pre-tested. Thereafter, the logic is executed to automatically customize the business application. The business application is customized visually through configurations.

The present invention further provides a method for automating development and customization of one or more business applications. Various examples of business applications may include, but are not limited to, Human Resource Management (HRM), Supply Chain Management (SCM), Customer Relationship Management (CRM), Inventory Management, Enterprise Content Management (ECM), and Enterprise Resource Planning (ERP). The method includes identifying one or more business requirements of a business application. The business requirements may change based on customer demands and market pressures. After identifying the business requirements, logic is designed by a designer based on the business requirements using one or more predefined reusable components. The predefined reusable components are pretested. Subsequently, the designed logic is implemented that leads to an automatic development of the business application and customization of the business application. The business application is developed and customized visually through configurations.

The present invention facilitates a framework for automatically customizing one or more business applications. The business applications are customized using configurations instead of conventional coding. The framework mentioned herein is disclosed in the form of a Rapid Design Toolkit (RDT). The framework further includes a plurality of predefined reusable components and an engine. The predefined reusable components are configured to design logic, based on one or more extensible business requirements. The predefined reusable components are pretested and can be customized according to the changing business requirements. Moreover, the engine, as described, is configured to execute the logic, thereby facilitating customization of the business application. The business application is customized visually through configurations using the underlying product's standard configuration screens. In addition, the predefined reusable components can be used across different business applications.

The present invention describes a Computer Program Product (CPP) for use with a computer. The CPP includes a computer usable medium having a computer readable program code embodied therein for automatically customizing one or more business applications. The computer readable program code includes a program instruction means for identifying one or more extensible business requirements of a business application. The extensible requirements may be identified by an enterprise. The computer readable program code further includes a program instruction means for designing a logic using one or more predefined reusable components, based on the extensible business requirements. The predefined reusable components are pretested. Moreover, the computer readable program product includes a program instruction means for executing the logic to automatically customize the business application. The business application is customized visually through configurations. Finally, the business application can be deployed by an enterprise to improve its business processes.

### BRIEF DESCRIPTION OF THE DRAWINGS

Various embodiments of the invention will, hereinafter, be described in conjunction with the appended drawings provided to illustrate and not to limit the invention, wherein like designations denote like elements, and in which:

FIG. 1 illustrates an exemplary Rapid Design Toolkit (RDT) in which various embodiments of the invention may be practiced, in accordance with an embodiment of the present invention;

FIG. 2 shows system components for developing and/or customizing business applications, in accordance with an embodiment of the present invention;

FIG. 3 depicts a plurality of business/reusable components used for developing and/or customizing a business application, in accordance with an embodiment of the present invention;

FIG. 4 is an exemplary block diagram showing transaction boundary implementation details, in accordance with an embodiment of the present invention;

FIG. 5 is another exemplary block diagram illustrating transaction boundary implementation details, in accordance with an embodiment of the present invention;

FIG. 6 is yet another exemplary block diagram depicting transaction boundary implementation details, in accordance with an embodiment of the present invention;

FIG. 7 exemplifies a flow chart for automatically customizing one or more business applications, in accordance with an embodiment of the present invention; and

FIG. 8 shows a bar chart depicting graphical results when a business application is developed and/or customized using a RDT, in accordance with an embodiment of the present invention.

### DETAILED DESCRIPTION OF THE INVENTION

The present invention discloses a novel framework which facilitates an automatic development and/or customization of business applications. In particular, the present invention provides a Rapid Design Toolkit (RDT) for customizing business applications according to varying business requirements. The customization is performed through configurations instead of traditional way of coding. Various examples of business applications may include, but are not limited to, Enterprise Resource Planning (ERP), Warehouse Management, Transportation Management, Returns and Settlement operations, Order Management, and Supply Chain Management (SCM). Moreover, the business applications can be developed in any of the programming languages for example, but not limited to, C, C++, C# (ASP.Net), Visual Basic (VB), VB.Net, Java, JavaScript, and Visual FoxPro.

For the sake of simplicity and better understanding, the invention will be explained using a Sterling Multi-Channel Fulfillment (MCF) solution, also known as ‘Yantra’. Sterling MCF is one of the most common platforms or products in the ERP and the SCM domain. In particular, Sterling MCF provides integrated solutions to its customers, including order management, warehouse management, transportation & delivery management, supply management, and so forth. Sterling MCF solution is developed using a framework known as Sterling MCF service definition framework. Thus, for a person skilled in the art, it is understood that the business application/solution mentioned herein is exemplary in nature and is simply used to describe the present invention. There may be other business solutions or business applications for which the methodology of the present invention can be implemented. Accordingly, it has been made clear that the invention is not limited to the embodiments described herein.

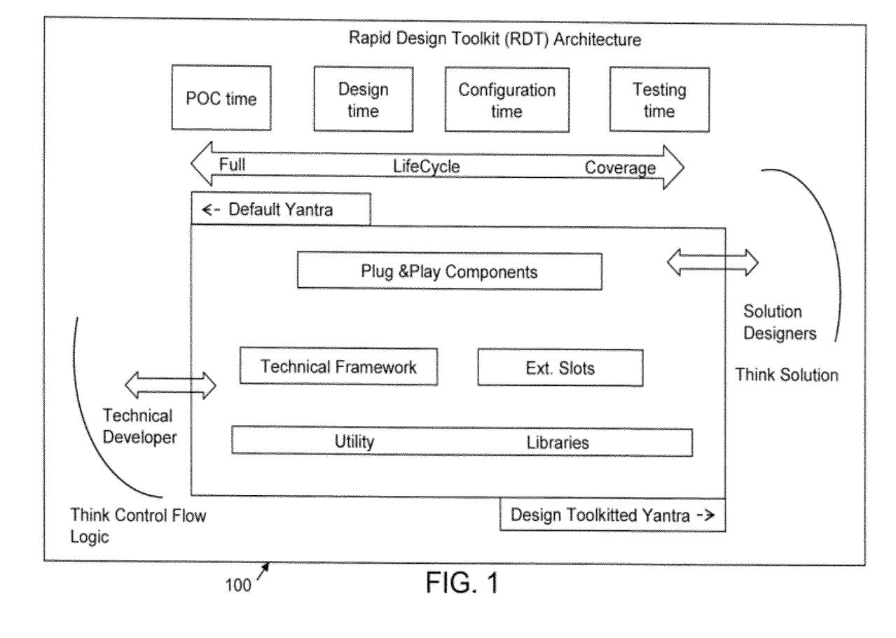

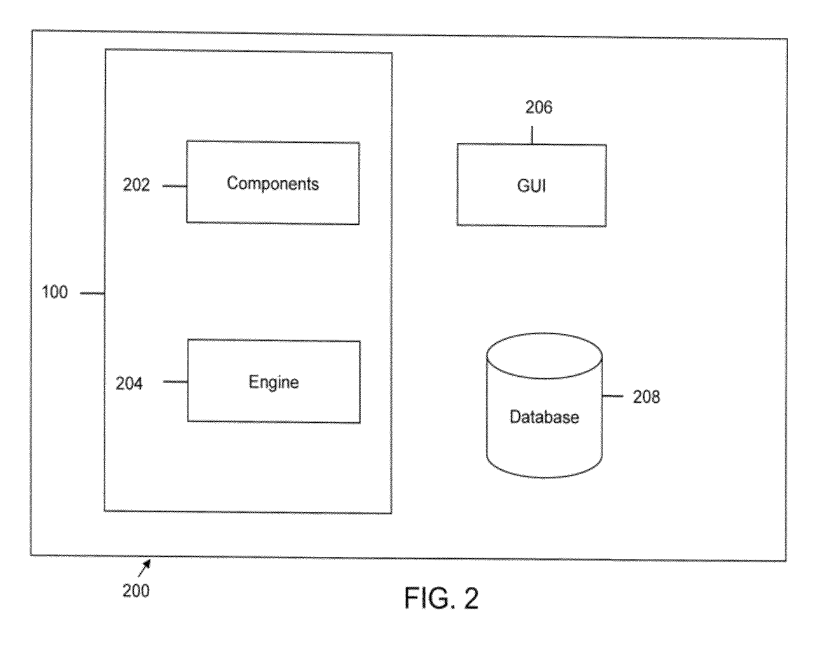

FIG. 1 illustrates an exemplary Rapid Design Toolkit (RDT) 100 in which various embodiments of the invention may be practiced, in accordance with an embodiment of the present invention. To describe the framework illustrated in FIG. 1, references will be made to FIGS. 2, 3, 4, 5, 6, 7, and 8, although it will be apparent to those skilled in the art that the implementation details of the figure can be applicable to any other embodiment of the present invention.

RDT 100 primarily aims at addressing challenges faced by Sterling MCF solution. The major issues confronted while developing/implementing Sterling MCF according to the business needs and customer demands, are a result of its programming-oriented approach. One of the major challenges is the high degree of development involved while customizing the solution. Further, for any simple and smallest customization, coding is required. This in turn leads to increased cost, time to implement, time to test, and increased risk exposure. Moreover, any change at a later stage also requires that changes be made in the initial stages such as coding, reviewing, testing, and rework. This eventually leads to an increase in review effort on code and a huge amount of time to implement product functionalities. To meet these challenges, the present invention proposes RDT 100. RDT 100 leverages the existing functionalities of the Sterling product infrastructure. RDT 100 focuses on abstracting the boundaries of the functionality such that extension /customizations become recomposable through the Sterling product infrastructure.

More specifically, RDT 100 identifies gaps in Sterling MCF infrastructure or identifies Out of Box (OOB) product capabilities according to the changing business needs. To fill the identified gaps, RDT 100 facilitates product extensions by providing main functionality, which is not limited to Reusable Custom Functionality (RCF). Further, functionalities such as Product Functionality (PF) and Custom Functionality (CF) are provided by Sterling product infrastructure based on the requirements. RCF is combined with the PF or CF to obtain control flow logic. The process of product extension/configuration includes database extension and custom control flow development. Moreover, RDT 100 renders writing code to “drag & drop” approach or plug-in predefined common components. Accordingly, RDT 100 configures the business solutions to perform the desired tasks.

As shown in FIG. 1, RDT 100 is a framework for automating customization in various business applications. The customization is performed visually through configurations. The process of customizing the business application further involves identifying Yantra extensible demands, building new blocks, building new components according to the requirements, enhancing the existing components, and testing performance of the newly built components.

In accordance with an embodiment of the present invention, RDT 100 may often be called as software development and configuration framework. RDT 100 can be used for various stages in the Software Development Life Cycle (SDLC), for example, development, design, coding, testing, and so forth.

RDT 100 includes a technical framework, extension slots, utilities, standardized libraries, and engine. In particular, the main components of RDT 100 include a plurality of components 202 and an engine 204, as shown in FIG. 2. Components 202 may be called as business components or predefined reusable components.

Further, FIG. 2 is shown to include a GUI 206 and a database 208, which form a part of the Sterling product infrastructure. GUI 206 facilitates drag and drop approach. Database 208 stores information such as logic and business application.

As mentioned above, engine 204 is used to execute the logic developed by designers. Moreover, RDT 100 includes a plurality of predefined reusable components to meet the business requirements of an enterprise in a standardized manner. The predefined reusable components may often be called as plug and play components or business components. These components develop the core application package extensible infrastructure such that a rapid creation of extensions is visually enabled. As the name suggests, the predefined reusable components can be used across various business applications, thereby bringing a level of standardization to the customization process. Using these components, designers can sketch the complete extension logic such that the business application performs the desired tasks. As RDT 100 enables solution designers to design the entire logic, the focus of control of the final business solution gets shifted from implementers to the designers. As a result, customization speed gets enhanced and time-to-implement gets reduced, reusability support is improved, and the solution quality becomes better. Moreover, the solution design becomes more abstract and the developed services become more reusable with RDT 100. Additionally, designers can design the complete solution using the predefined reusable components which is more abstract, reusable, and maintainable. Programmers can use the design to develop the solution in a much faster way by using minimal testing.

The predefined reusable components are generic services based on Sterling service definition framework providing common functionalities, thereby, bringing in a level of standardization to customization. Each component performs a generic technical task that usually would involve coding. However, RDT 100 ensures that customization requires less effort for developing or extending the existing code. Various types of predefined reusable components may include, but are not limited to, production components and development components. The production components may often be called as testing components. The predefined reusable components can further be plugged into the Sterling service definition framework. These components are built by leveraging the existing Sterling MCF technical infrastructure to provide additional functionality that is commonly needed, thereby, supporting reusability, increasing productivity, and promoting consistency.

In accordance with an embodiment of the present invention, the predefined reusable components may be customized /configured according to the varying business requirements. In accordance with another embodiment of the present invention, the predefined reusable components may be created according to the varying/extensible business requirements. Once built, these components are tested for performance by the designers.

In accordance with an embodiment of the present invention, reusable components of RDT 100 can be installed on various Operating System (OS) platforms, but are not limited to, Microsoft Windows, Linux, Unix, Sun Solaris, Hewlett Packard UniX (HP-Unix®), and Advanced Interactive eXecutive (IBM AIX).

In accordance with a preferred embodiment of the present invention, RDT 100 can be implemented for various SCM applications, including, but not limited to, order management, warehouse management, and transportation management.

Examples of various technologies used for customizing the business solution using RDT 100 may include, but are not limited to, Eclipse IDE, Extensible Markup Language (XML) parsers, Object Pool, Visual SourceSafe (VSS), Apache Ant™, Java 1.5, and Web logic/Oracle.

Developing and/or customizing business solutions using RDT 100 provides a number of advantages over the conventional methods and solutions. For example, RDT 100 reduces the development time since customizations/extensions can be accomplished through configurations without much coding effort. Due to configuration-based development, RDT 100 facilitates easy maintenance of solutions. Further, RDT 100 enhances the quality of solutions as the components used for developing and/or customizing the business solutions are pretested. Moreover, development and/or customization of business solutions do not require in-depth technical or functional knowledge. Additionally, RDT 100 helps in increasing productivity and in reducing the cost of ownership and implementation time. RDT 100 also supports reusability of the components.

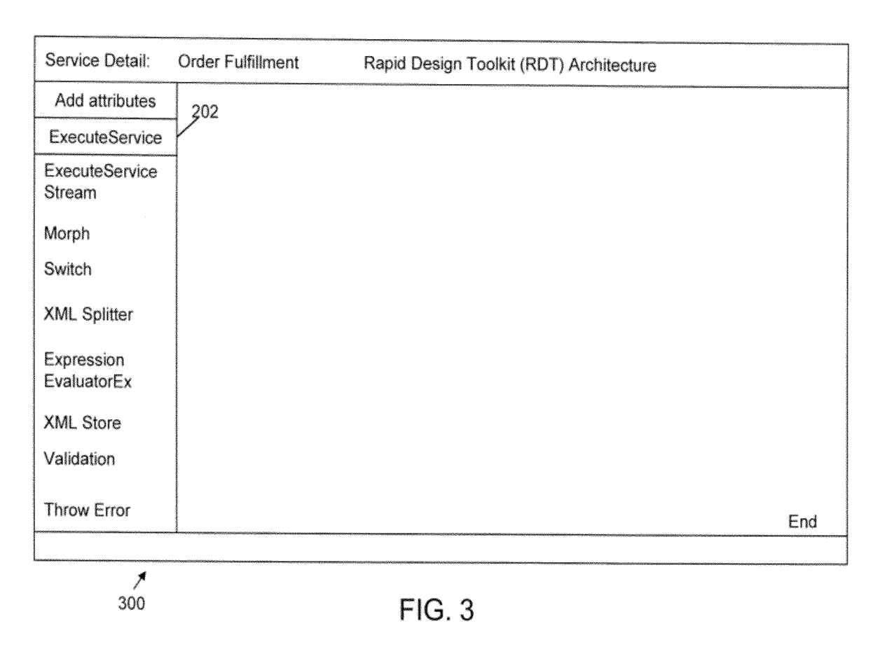

FIG. 3 depicts a plurality of business/reusable components used for developing and/or customizing a business application, in accordance with an embodiment of the present invention. To describe FIG. 3, references will be made to 1, 2, 4, 5, 6, 7, and 8, although, it will be apparent to those skilled in the art that the implementation details of the invention can be applicable to any other embodiment of the present invention.

FIG. 3 shows an exemplary environment 300 for developing and/or customizing a business application using predefined reusable components. In particular, FIG. 3 depicts software elements, such as one or more business components.

In accordance with an embodiment of the present invention, the business components can be installed on machines having Operating System (OS), for example, UNIX and Windows. The installation process includes enabling logging of RDT classes.

Various examples of business components may be, but are not limited to, production and testing components. The production components are those which can become a part of any business application design. Examples of such production components, as shown in FIG. 3 may be, Add Attributes, ExecuteService, ExecuteServiceStream, Morph, Switch, XML Splitter, Expression EvaluatorEx, XML Store, Validation, Throw Error, DBHelper, Base Agent, Sort, Encryption Decryption Utility, Remove Attributes/Elements, CommonCode Utility, and so forth. These production components represent the Reusable Custom Functionality. Further, the testing components are those which can be used only during the development phase. Such components may include, but are not limited to, Echo and XMLPipe. In accordance with an embodiment of the present invention, the testing components may form a part of the end solution. In accordance with another embodiment of the present invention, the testing components may not form a part of the end solution.

In accordance with various embodiments of the present invention, the use of various business components in the “Order Management” solution has been described. In accordance with an exemplary embodiment of the present invention, the use of “XML Splitter” component in “Order management” solution has been explained. The “XMLSplitter” method can be used to retrieve shipment numbers for a list of orders. Further, “getShipmentNo” service can be used to fetch the shipment number for a given order number. In this case, the input and output XML of “getShipmentNo” may include the following:

Input

<OrderLine OrderHeaderKey=“123456”/>

Output

<Shipment ShipmentNo=“455445”/>

In a similar manner, “XMLSplitter” method can be used to retrieve the shipment number for a multiple order numbers. While using “XMLSplitter”, the input may be as follows:

Input:

<Order>

<OrderLines>

<OrderLine OrderHeaderKey=”123456”/>
<OrderLine OrderHeaderKey=”654321”/>
<OrderLine OrderHeaderKey=”987654”/>

</OrderLines>

</Order>

Here, four argument sets are used for the “XMLSplitter” method, based on the requirements and the available inputs. The following tables list out the four sets and their respective inputs and outputs.

Argument List 1

| Input Arguments | |
|---|---|
| Child_Element | Order/Orderliness’/OrderLine |

Merge_Output Y
Service_Name getShipmentNo

Output

<Order>

<OrderLines>

<OrderLine OrderHeaderKey=”123456”>

<Shipment ShipmentNo=”545456”/>

</OrderLine>
<OrderLine OrderHeaderKey=”654321”>

<Shipment ShipmentNo=”56437”/>

</OrderLine>
<OrderLine OrderHeaderKey=”987654”>

<Shipment ShipmentNo=”43654”/>

</OrderLine>

</OrderLines>

</Order>

In accordance with another exemplary embodiment of the present invention, “Echo” component may be used while debugging to log the intermediate XMLs within a service definition framework.

In accordance with further exemplary embodiment of the present invention,” The AddAttributes” component has been described herein. “The AddAttributes” component adds or overwrites an attribute in the given input xml. It creates the attribute, if it does not exist, and overwrites its value, if it is exists. The component can be used in scenarios where service is being called from another API or when service does not have all the required attributes. This component can be used in a scenario where the information sent from one service is always dynamic and depends on the standard values of some of the attributes, before passing it on to the next service.

In accordance with yet another exemplary embodiment of the present invention, “The ExecuteService” component is described herein. “The ExecuteService” component invokes another service, based on the argument configuration of the service. This component is used for reusing the existing services and can also be used for modularizing complex service definitions.

In accordance with one or more exemplary embodiment of the present invention, an “ExpressionEvaluator” component is described. It is a versatile decision-making tool that evaluates a complex set of expressions, and then continues the flow in one of the two different paths based on the evaluation output. This component can be used in such scenarios where the expressions for conditions need to be configured. This reduces the effort required for developing an extension code for each case. It is recommended that a complex expression should be used in “ExpressionEvaluator” than using a chain of expression evaluators.

In accordance with an embodiment of the present invention, arguments for each component may be set using arguments setting list, as available in the properties section of each component. Examples of various properties of the component may be, but not limited to, Service_Name, XPath, and Attribute_Name.

In accordance with an embodiment of the present invention, different queries will be taken from the database (DB). Various types of databases may include Microsoft SQL Server, Oracle DB, include MS Access™, MS Excel™ and so forth.

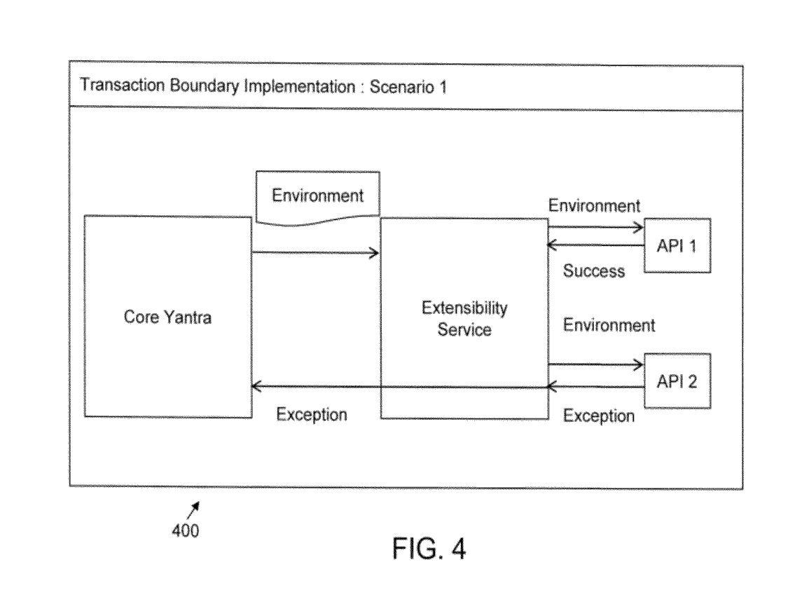

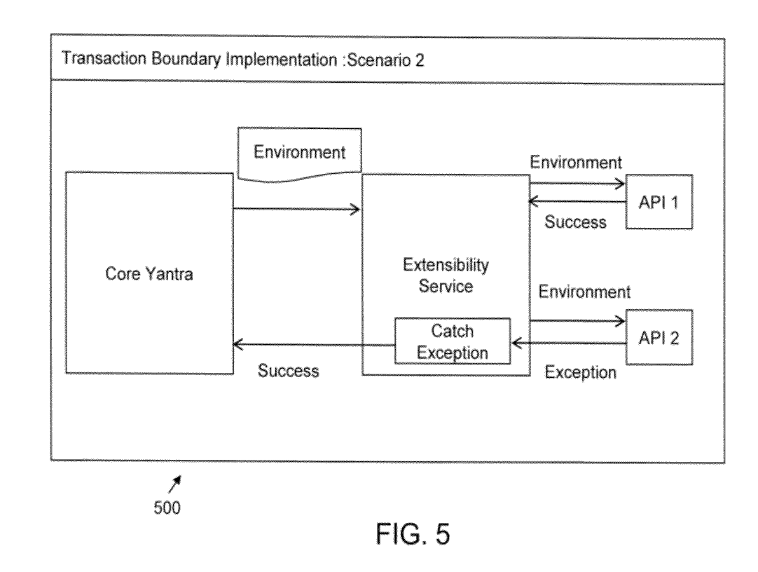

In accordance with an embodiment of the present invention, various scenarios related to transaction boundary implementations have been explained herein. In scenario 1, as depicted in FIG. 4, a service is invoked by Yantra with an environment handler. The service can call multiple APIs with the handler. If any of the API fails, then all the APIs are rolled back. Here, the exception message is returned to Yantra which results in rolling back of all the API transactions. If the service processes the second APIs exception and returns a “Success” to Yantra, then the transaction of API1 is not rolled back. Here API1's transaction is committed and API2's transaction is rolled back. This constitutes scenario 2, as demonstrated in FIG. 5.

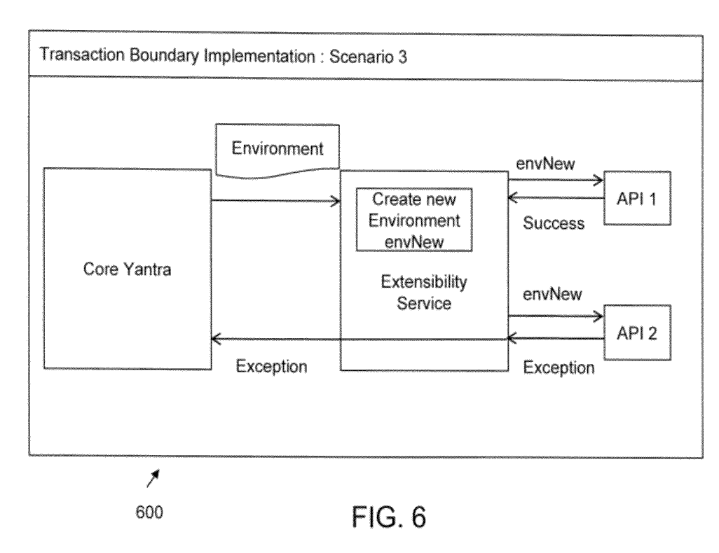

FIG. 6 shows (scenario 3) that the custom service can also be designed to create its own environment handler and to invoke APIs. According to this scenario,

API1's transaction is committed and API2's transaction is rolled back. The scenario of calling multiple APIs using XMLSplitter falls under Scenario 1. All the APIs are being invoked with the same environment handler as passed by Yantra. Therefore, if any of the API fails, then all the API transaction is rolled back.

For a person skilled in the art, it is understood that the program codes as described above are exemplary in nature and are simply used to facilitate the description of the present invention. The program codes depicted above may be written in any programming languages. The program codes may or may not represent the completeness of a component; however, they are sufficiently described in a sequence corresponding to the features described above. Thus, it is clear that the invention is not limited to the embodiments described herein.

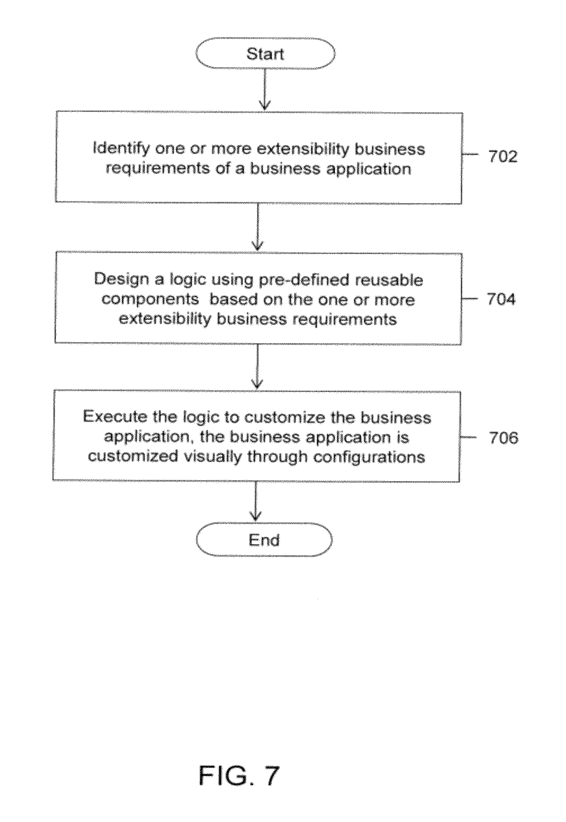

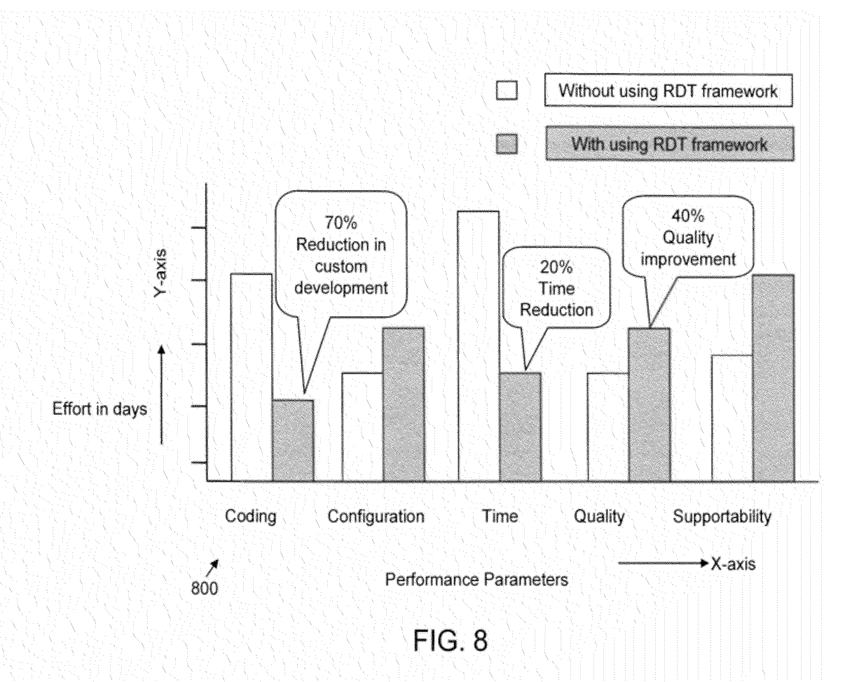

FIG. 7 exemplifies a flow chart for automatically customizing one or more business applications, in accordance with an embodiment of the present invention. To describe the method illustrated in FIG. 8, references will be made to FIGS. 1, 2, 3, 4, 5, 6, and 8, although, it will be apparent to those skilled in the art that the implementation details of the invention can be applicable to any other embodiment of the present invention.

The main objective of FIG. 7 is to describe the methodology involved in customizing various business applications, in particular, Sterling MCF applications.

At 702, one or more extensible business requirements of a business application are identified. Thereafter, the extensible requirements are identified. Once identified, the extensible business requirements are analyzed in detail by the designers. In accordance with an embodiment of the present invention, the extensible requirements may be broken down into smaller parts when the requirements are immense. After analyzing the requirements, designers finalize the approach to customize the business application and to determine the subsequent steps.

Accordingly, at 704, logic is designed using one or more pre-defined reusable components based on the extensible business requirements. The entire logic is designed by the designers. In accordance with another embodiment of the present invention, the logic may be designed by programmers. While designing the logic, reusable components are connected with control flow logic or connected with other business reusable components.

In accordance with various embodiments of the present invention, the process of designing the logic may include Iteration, Flow Control, Aggregation, Validation and Error Handling, Simple XML Operations, Prototyping, and Debugging. Iteration may include looping over XML elements for repeated processing. Further, Flow Control includes if—then—else constructs and calls other functionality. Further, Aggregation includes merging XML documents from services. Validation and Error Handling, Simple XML operations, Prototyping, and Debugging processes are well known in the art and, may be referred to when required.

In accordance with further embodiment of the present invention, the process of designing the logic may include building various functional modules. Examples of various functional modules may be, but are not limited to, Custom Functionality (CF), Reusable Custom Functionality (RCF), and Product Functionality (PF). RCF and CF are built using the predefined reusable components.

In accordance with an embodiment of the present invention, customizing the business application includes extending functionalities of a database.

Referring to the flowchart above, once the logic is designed, at 706, it is executed to customize the business application; the business application is customized visually through configurations. The execution of the designed logic includes parsing and validations. Parsing and validation may be executed using, but not limited to, XML (Extensible Markup Language) parsers. It must be noted that these steps are well known in the art and may accordingly be referred to when required.

In accordance with an embodiment of the present invention, the predefined reusable components may be customized with varying business requirements. The predefined reusable components may be customized by simply changing the properties. In accordance with another embodiment of the present invention, new reusable components may be built based on the business requirements. In accordance with an embodiment of the present invention, the reusable components can be built in one or more predefined programming languages as described above.

In accordance with an embodiment of the present invention, the predefined reusable components can be plugged into Sterling infrastructure. Accordingly, Sterling MCF solution can be configured to perform the desired task. For example, a set of Java components can be plugged into the Sterling MCF framework.

In accordance with an embodiment of the present invention, the predefined business components are performance tested. For example, the components may be tested for live usage scenarios. In another example, the components may be tested for leaks, response times, and Central Processing Unit (CPU) utilization. In yet another example, the components may be tuned for component-level performance. Various tools for testing the components may include, but are not limited to, Vmstat (virtual memory statistics), HP-Jtune, and Open System Testing Architecture (OpenSTA).

Once the business application is customized using the methodology as discussed above, the business application is tested for logical accuracy and efficiency of the components used. Following this, the business application is ready to be released. Consequently, the business application is deployed in an enterprise to address different business needs and processes.

The customization of business application using the method as described in the flowchart demonstrates better performance. FIG. 8 shows a bar graph representing a relation between effort in days by programmers/designers and performance parameters such as coding, configuration, time, quality, and supportability. In particular, FIG. 8 exemplifies that development and/or customization of the business application using the approach described above leads to 70% reduction in custom development, 20% reduction in time, and 40% improvement in quality. Additionally, the method supports reusability of the components.

In accordance with an embodiment of the present invention, the methodology as described in FIG. 7 may be applicable for developing the business application. The developed business application can be maintained in a database.

The method and system described above have numerous advantages. The present invention provides a unique framework for automating customization in business applications. The automatic approach of customization reduces the degree of customizations, cost of ownership, and development/implementation time, thereby facilitating easy maintenance of the business application. Further, the business application is customized through configurations; therefore it does not need any highly skilled programmers. Moreover, the framework facilitates reusable common components, thereby bringing standardization in the customization of applications. This, in turn, increases productivity, supports reusability of components, and promotes consistency. Moreover, the components provided by the framework are pretested, thus, the overall time for testing the business application is reduced. Additionally, the framework helps in making the business application design more abstract.

The method and system for automating development and customization of business applications, or any of its components, as described in the present invention, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method for the present invention.

The computer system typically comprises a computer, an input device, and a display unit. The computer typically comprises a microprocessor, which is connected to a communication bus. The computer also includes a memory, which may include a Random Access Memory (RAM) and a Read Only Memory (ROM). Further, the computer system comprises a storage device, which can be a hard disk drive or a removable storage drive such as a floppy disk drive and an optical disk drive. The storage device can be similar to other devices that are used for loading computer programs or other instructions into the computer system.

The computer system executes a set of instructions that are stored in one or more storage elements to process the input data. These storage elements can also hold data or other information, as desired, and may be in the form of an information source or a physical memory element present in the processing machine. Exemplary storage elements include a hard disk, a DRAM, an SRAM, and an EPROM. The storage element may be external to the computer system and connected to or inserted into the computer, to be downloaded at or prior to the time of use. Examples of such external computer program products are computer-readable storage mediums such as CD-ROMS, Flash chips, and floppy disks.

The set of instructions may include various commands that instruct the processing machine to perform specific tasks such as the steps that constitute the method for the present invention. The set of instructions may be in the form of a software program. The software may be in various forms such as system software or application software. Further, the software may be in the form of a collection of separate programs, a program module with a large program, or a portion of a program module. The software may also include modular programming in the form of object-oriented programming. The software program that contains the set of instructions (program instruction means) can be embedded into a computer program product for use with a computer, the computer program product comprising a computer usable medium with a computer readable program code embodied therein. Processing of input data by the processing machine may be in response to users' commands, results of previous processing, or a request made by another processing machine.

The modules described, herein, may include processors and program instructions that are used to implement the functions of the modules described herein. Some or all the functions can be implemented by a state machine that has no stored program instructions, or in one or more Application-specific Integrated Circuits (ASICs), in which each function or some combinations of some of the functions are implemented as custom logic.

While the various embodiments of the invention have been illustrated and described, it will be clear that the invention is not limited only to these embodiments. Numerous modifications, changes, variations, substitutions, and equivalents will be apparent to those skilled in the art, without departing from the spirit and scope of the invention.

What is claimed is:

1. A method for automatically customizing one or more business applications, the method comprising:
a. identifying one or more extensible business requirements of a business application;
b. designing a logic using one or more pre-defined reusable components, based on the one or more extensible business requirements, the one or more pre-defined reusable components are pre-tested; and
c. executing the logic, the execution of the logic facilitates automatic customization of the business application, the business application being customized visually through configurations.

2. The method according to claim 1 further comprising maintaining information related to the business application.

3. The method according to claim 1 further comprising creating one or more reusable components based on the one or more extensible business requirements.

4. The method according to claim 1 further comprising configuring the one or more pre-defined reusable components based on the one or more extensible requirements.

5. The method according to claim 1 further comprising extending functionalities of a database.

6. The method according to claim 1, wherein the one or more extensible business requirements are identified by an enterprise.

7. The method according to claim 1, wherein one of the one or more business applications is Sterling Multi-Channel Fulfillment solution.

8. The method according to claim 1, wherein the business application is developed in one or more pre-defined programming languages.

9. The method according to claim 1, wherein the one or more pre-defined reusable components are customized according to the one or more extensible business requirements.

10. The method according to claim 1, wherein the one or more pre-defined reusable components are used to build Reusable Custom Functionality (RCF), and Custom Functionality (CF).

11. The method according to claim 1, wherein the one or more pre-defined reusable components are plugged into a pre-defined framework of the business application.

12. The method according to claim 1, wherein the one or more pre-defined reusable components are used across different business applications.

13. A method for automating at least one of: development and customization of one or more business applications, the method comprising:
a. identifying one or more business requirements of a business application;
b. designing a logic using one or more pre-defined reusable components, based on the one or more business requirements, the one or more pre-defined reusable components are pre-tested; and
c. executing the logic facilitating at least one of:
automatically development of the business application and customization of the business application, the business application being developed and customized visually through configurations.

14. The method according to claim 13 further comprising creating one or more reusable components based on the one or more business requirements.

15. The method according to claim 13, wherein the business application is developed in one or more pre-defined programming languages.

16. A framework for automatically customizing one or more business applications, the framework comprising:
a. a plurality of pre-defined reusable components, the plurality of pre-defined reusable components being configured to design a logic, based on one or more extensible business requirements, wherein the plurality of pre-defined reusable components are pre-tested; and
b. an engine, the engine being configured to execute the logic facilitating customization of the business application, the business application being customized visually through configurations.

17. The framework according to claim 16, wherein the business application is developed in one or more pre-defined programming languages.

18. The framework according to claim 16, wherein the plurality of pre-defined reusable components are generic services providing common functionality.

19. The framework according to claim 16 further comprising one or more standardized libraries.

20. The framework according to claim 16 further comprising one or more utilities.

21. A computer program product for use with a computer, the computer program product comprising a computer usable medium having a computer readable program code embodied therein for automatically customizing one or more business applications, the computer readable program code comprising:
a. a program instruction means for identifying one or more extensible business requirements of a business application;
b. a program instruction means for designing a logic using one or more pre-defined reusable components, based on the one or more extensible business requirements, the one or more pre-defined reusable components are pre-tested; and
c. a program instruction means for executing the logic to automatically customize the business application, the business application being customized visually through configurations.

22. The computer program product according to claim 21, wherein the business application is developed in one or more pre-defined programming languages.
